(19) United States
(12) Patent Application Publication
(10) Pub. No.: US 2006/0047583 A1
(43) Pub. Date: Mar. 2, 2006

(54) Method and system for empowering purchasers to maximize economies of scale

(76) Inventor: Jim Jacobs, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/926,516

(22) Filed: Aug. 25, 2004

(51) Int. Cl. G06F 17/30

(52) U.S. Cl. 705/27

(57) ABSTRACT

Systems and methods are provided wherein participating consumers lower an average cost of a product through purchasing larger packaged quantities of the product in a cooperative though anonymous style arrangement. A list of products is displayed on a terminal for participating consumers. The products include bulk-packaged items, for example a case of ketchup, or cargo ship of grain. Each participating consumer chooses a desired number or amount of an item that comprises the larger packaged product. A controller keeps track of the total number of each item orders such that when a large enough number of the item is requested or ordered, an order is placed to a product distributor. Typically, the larger packaged quantity of the product is ordered when a condition is met. Conditions may include either a deadline closure or when enough single items are requested to equal or exceed the number of items packaged in the larger quantity bulk packaged form.

There are no related applications.

This application did not receive federal research and development funding.

### BACKGROUND OF THE INVENTION

The present invention relates to systems and methods that allow anonymous participating consumers to maximum economies of scale to increase the purchasing power of the participating consumers and reduce the overall cost incurred when purchasing an item. Particularly, the present invention relates to a system and method that allows a plurality of consumers to readily purchase goods at a discounted priced. By combining the purchasing power of participating consumers, goods are bought in bulk which reduces the per unit cost. The goods are delivered to a centralized location, and made available for pickup by the participating consumers or delivery by common carrier, or other delivery method. The small costs of administering the program, providing a central location, and distributing the costs, is far less than the savings incurred by buying in large quantities. The result is that the overall cost of each item to a participating consumer is less than the price if purchased at a retail store by a single consumer.

Previously, many consumers have participated in co-ops, which supply consumers with food or other goods. A co-op or buying club typically comprises several families who know each other and share the chores of collecting money from the member families to place an order with a distributor of goods. A distinguishing feature of this style co-op is familiarity with other members. The distributor then fills the order and a delivery of the purchased items occurs. Typically, the distributor drop ships the purchased items to the co-op or other designated place. The co-op members unload and separate the ordered items upon the arrival of the delivery truck. The members of the co-op must know one another and have to contact each other via telephone, in-person, email etc. in order to allocate the bulk quantity. This is a very costly, time-consuming, and error prone process. A central feature of co-ops is the ability to (manually) split larger quantities among the membership—since most members do not want to make bulk purchases.

There are problems associated with a co-op. First, the director or coordinator coordinating all activity of the co-op is usually charged with insuring that the requested items are ordered, as well as collecting money. Also, the director is burdened with distributing the purchased items to the individual consumer. It is also very difficult in some instances to accurately account for ordered goods, since many consumers are fickle and change their minds often. And, sorting and allocating the goods upon delivery requires much time and is subject to error.

Other problems associated with the co-ops are that they typically lack operating funds. Thus, those who invest their time operating the co-op do not always benefit. Soon running the co-op becomes a great burden and the co-op fails. To address this problem, co-ops traditionally rotate the responsibilities of director or coordinator. However, this creates various operational problems that can contribute to co-op failure. Another problem is that co-ops typically require members to volunteer labor to reduce costs. The present invention does not operate in this manner.

The proposed system is distinguished from the tradition bulk buying programs in several ways while maintaining the overall goal. First, the participating consumers may be anonymous to one another while still enjoying the benefits of a cooperative style relationship. It is readily recognizable that the participating consumers may be numerous. Thus, the instant invention is a self-serve business model that does not require participating consumers to know one another. To applicant's knowledge, this invention has not been practiced previously and would have been impossible before the creation of a universal communication medium such as the Internet. While the present invention contemplates the use of multiple anonymous users, it is readily recognized that the invention may be readily used by individuals who are known to one another. However, by allowing users that are anonymous to one another to participate, the pool of participating consumers may be vast.

In a preferred embodiment, a “members” database comprising “email”, “last sent”, “splits confirmation email”, “daily splits email” and “pay reference” is used. The “email” portion of the database denotes an email address of the participating consumer. It is necessary since virtually all communication between the administrator or controller is electronic in nature. “Last sent” indicates the date the controller or administrator sent email to the participating consumer, such as the current splits availability list. “Splits confirmation email” indicates whether the participating consumer will get email confirming splits (where participating consumers purchase a portion of a greater bulk quantity to include the entire amount packaged in bulk) that the consumer had signed up to participate in. “Daily splits email” indicates whether the participating consumer desires to receive a periodic, e.g. daily email listing the splits available that the consumer may participate in. If the consumer is participating in any splits the email may include the quantity requested by the consumer in each split. “Pay reference” indicates a reference such as a credit card number. The code may be used by the controller to allow a consumer to participate in a split.

Another database that may be included in the process is a “splits” database that includes a “splits identifier” that is a unique identifier, usually a numeric type, for a specific record. An “item Identifier” is a unique identifier, usually a numeric type, for a specific inventory item. A “member identifier” is a unique identifier, usually a numeric type, denoting a specific customer. “Status” denotes the state of the split request, ie. active, inactive, on hold, etc. “Backup time” denotes the date and time when the status record was last saved. “Last access” is the date and time when the record was last accessed by the customer. “Created” is the date and time when this record was first created. “Last email” is the date when this record was last emailed to the customer list. “Quantity wanted” is the number of units within the case that the customer wants. “Pieces” is the number of units within the case (set by the manufacturer). “Remove items” is a flag that tells the program to remove regular orders for the same item if the “split” is successful. “Order items” is the number of unit items the customer wants to order in the event the “split” is not successful (these are typically sold at a slightly higher price). “Will_take_case” is a flag indicating whether the customer will take the balance of a case in order to make sure the “split” is filled. “Max Quantity” denotes the maximum the customer is willing to take, which is at least equal to the quantity wanted but may be greater, up to the entirety of the quantity available. “Limit” denotes the maximum number of items that may be split. It ranges between 1 and infinity. Although there may be an infinite number of units of bulk items, the process may take into account that there could be a limited supply of items, e.g. close out items. When all of the limited supply is allocated, the split condition is triggered and the fulfillment/ordering process begins.

A “closed splits” database is a duplicate of the “splits” database. During the open order period, it serves no function. When the “trigger”occurs such as when a certain condition is met (e.g. the order period reaches the close date/time), all information in the “splits” database is transferred to this database. This allows the “splits” database to immediately begin collecting new splits for the following order period. The open split period typically ranges between a day and a month but may be of any length of time.

The “splits history” database is a near duplicate of the “splits” and “closed splits” databases. It holds the historical information about splits requests. It has an added field entitled “close date” which is the period closing date. This allows all splits closed on that date to be grouped together for analysis or retrieval purposes.

“My order” database is an open period order database. This database maintains a flag indicating whether an item has a split.

“My closed order” database is a duplicate of the open period order database and is used as an interim database after the open order period is closed and before the final customer orders have been created.

“Order detail” is a database that is the final customer order. There could be a field in here which specifically indicates whether a particular line item came from a split or not, or that information could be elsewhere, e.g. coded into the item number and the unit name. Thus, the process determines which cases are being split and which ones are ordered “by the case”, which allows the controller to provide a “pick ticket” and routing information when getting things from “inventory” for filling orders.

A key objective is to provide a co-operative style arrangement whereby participating consumers may readily purchase goods and/or services at a substantially reduced rate. However, a great amount of the present system is directed and maintained in an automated fashion. The automated fashion of the system allows a user to readily place and change a quantity for any offered product or good. Moreover, the automated fashion of the system lends itself to allowing participating consumers to be anonymous to one another. In addition, the distributor of the goods may or may not be anonymous to the participating consumer.

Another objective of the invention is to provide an on-line store-front that allows participating consumers to bypass retail stores and purchase goods directly from distributors or wholesalers at a substantially reduced price.

It is another object of the present invention to provide a new and improved system utilizing technology to implement an ordering process that empowers participating consumers to maximize economies of scale by lowering costs associated with items ordered by the participating consumers.

It is another object of the invention to provide a new and useful automated system and process which utilizes enabling technologies to implement a co-operative relationship between a plurality of participating consumers to create process that is advantageous to consumers as well as distributors.

### BRIEF SUMMARY OF THE INVENTION

The invention is a microprocessor based network for empowering participating consumers with greater purchasing power while reducing the average purchasing price of individual items. The invention comprises a network of participating consumers that each individually order a desired quantity of an item. The system allows a user to purchase individual items that are sold in bulk quantities.

When the requested quantity of an item equals or exceeds the amount of individual items packaged in bulk, an order may be placed with a distributor or manufacturer. For example, a dozen catsup bottles may be bundled in a package or case, in bulk. A consumer may want only two of the catsup bottles from the case; however, if the total case of catsup bottles are ordered and distributed, then the price per each item, or bottle of catsup, is substantially reduced. Thus, when enough participating consumers order twelve bottles of catsup, an order may be placed. The system allows users to order one or more items from a larger bulk unit e.g. a case.

This invention comprises a central processor comprising a product database, customer information database and operating instructions. In the product database, product names, number of items per case, and number of items ordered or requested is stored. In the customer information database, the name of the user, user ID, password, credit card information and contact information may be listed. Lastly, in the operating instructions database, instructions for accounting for the cases of ordered items and associating them with the correct consumer, as well as tabulating the total number desired items are included. The instructions allow a consumer to periodically update or change information in the system including items ordered. The process displays products to be purchased in large quantities on a participating consumer's terminal. The user then chooses the desired number of products and using a keyboard or other data entry means enters the desired quantity into the system. The processor(s) controlling the network then updates the information entered by the participating consumer, such that the total number of items per product is periodically updated. When a condition such as a deadline arises, or the total number of items equals the total number of items in a bulked quantity, the program may automatically order the requested items. That is to say, an order to a distributor of the bulk-packaged items may be placed automatically by a controlling processor.

By effectively combing the purchasing power of multiple consumers together, the price or purchased goods is drastically reduced. Benefits of the invention are readily realized by a participating consumer, since the price of the purchased item is reduced. Moreover, the invention supports distributors since consumers who may not have otherwise purchased the items at a higher cost can now afford to purchase the items.

Accordingly, the present invention provides a system and process whereby plurality of customers can bind together to purchase products in bulk. Products are then delivered to a central point and distributed to each of the purchasing consumers. That result is that the consumer has a decrease in the amount charged resulting in a more favorable economic position for the consumer. That is to say, the consumer will now have more of a disposal income, which allows the consumer to then purchase more items.

### BRIEF DESCRIPTION OF THE DRAWINGS

FIG. 1 is a block system diagram according to a preferred embodiment of the present invention.

FIG. 2A is a flowchart denoting the process carried out by the system depicted in FIG. 1.

FIG. 2B is an alternative flowchart denoting an alternative embodiment for carrying out the process.

FIG. 3 is a block diagram of the central processor depicted in FIG. 1.

FIG. 4A illustrates a database table for storing product information.

FIG. 4B illustrates a database table for storing customer information.

FIG. 4C is a database for use in implementing the present invention.

FIG. 4D is a database of a website catalog and listing multiple distributors and/or manufacturers for different items.

FIG. 4E is a database that is used to track the number of items ordered by all participating customers.

FIG. 4F is a database showing a breakdown of the items to be split according to manufacturers.

### DETAILED DESCRIPTION OF THE INVENTION

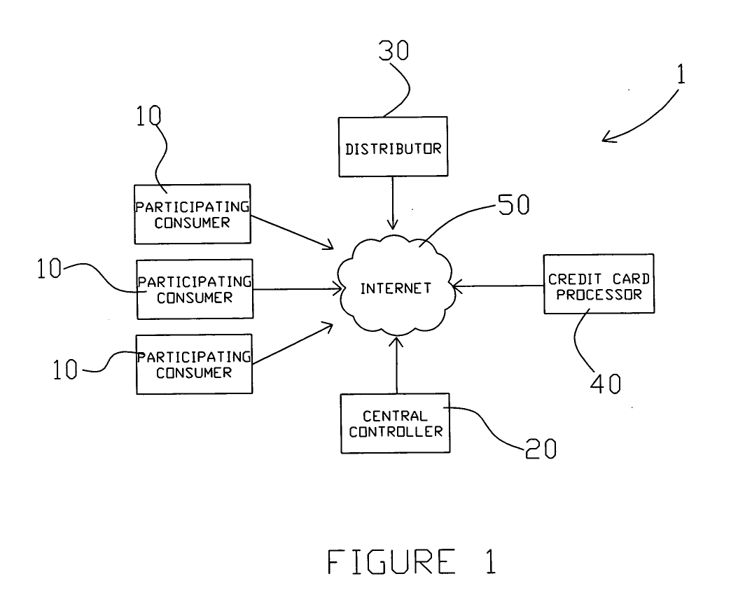

Referring now to FIG. 1, a block diagram of a system I for allowing participating consumers to pool their purchasing power thereby reducing the costs of purchasing various items is displayed. The participating consumers 10 initiate online contact with the central controller 20 through an Internet connection 50. The system 1 includes participating consumers' computers that operate a web browser or other appropriate network connection. The central controller 20 controls a data processing system that may be connected to at least one distributor 30 and a credit card processor 40 via the internet or through a telephone network.

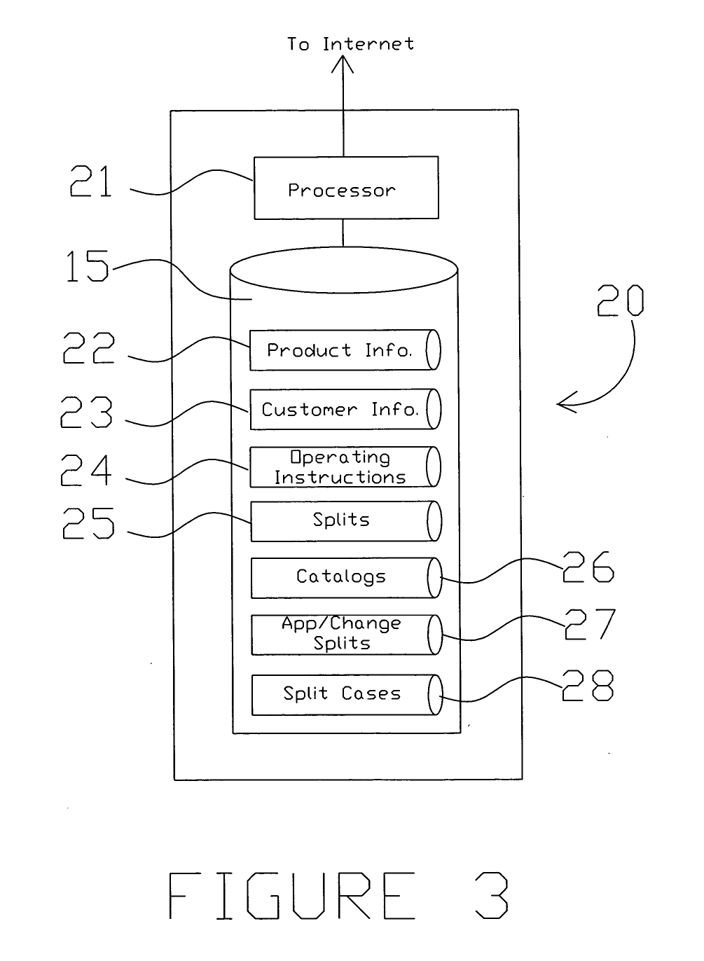

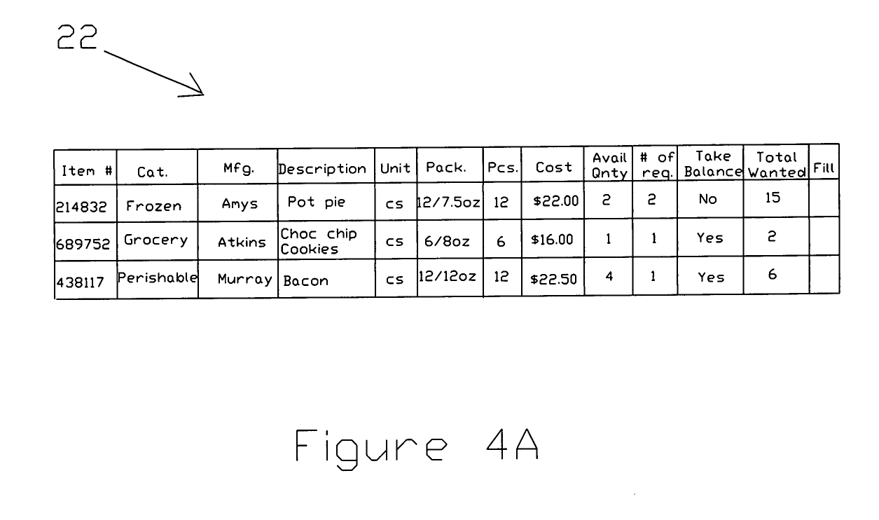

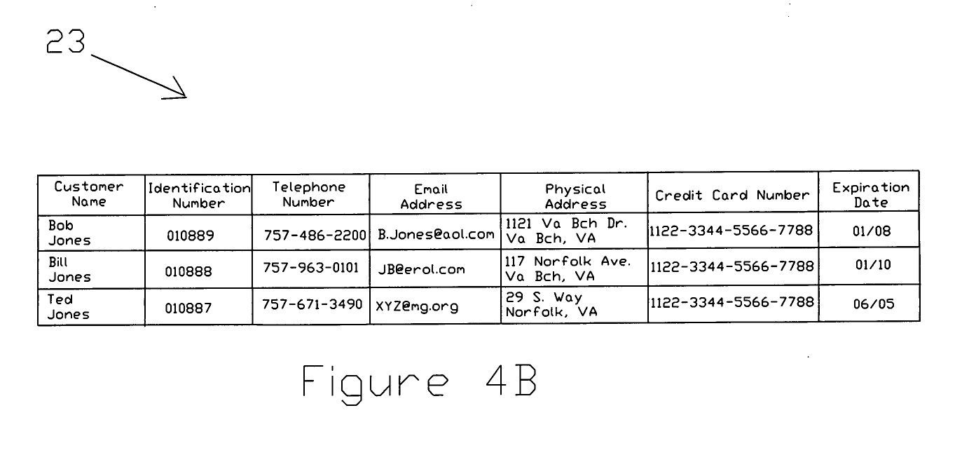

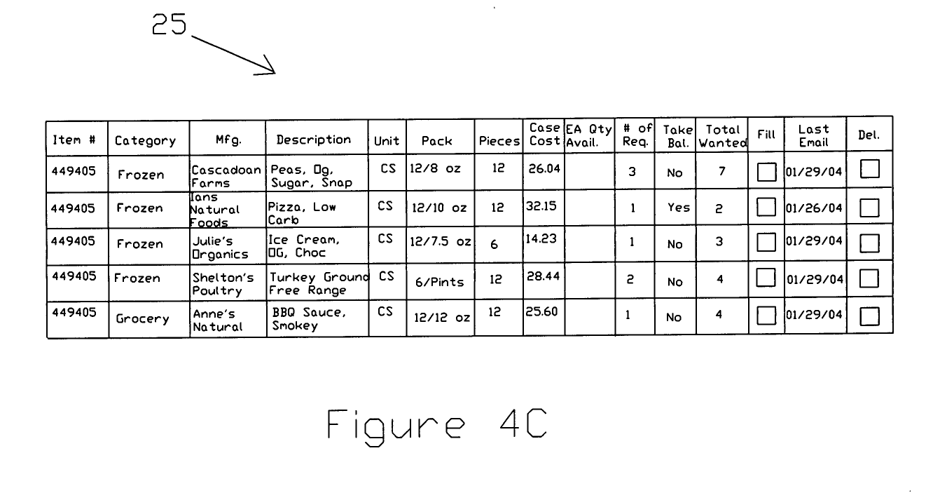

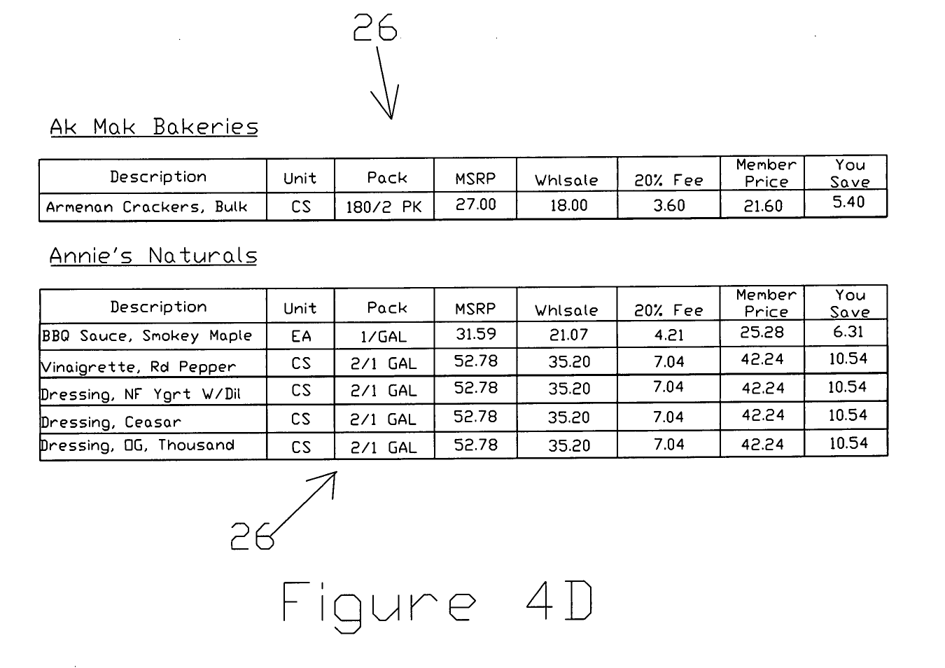

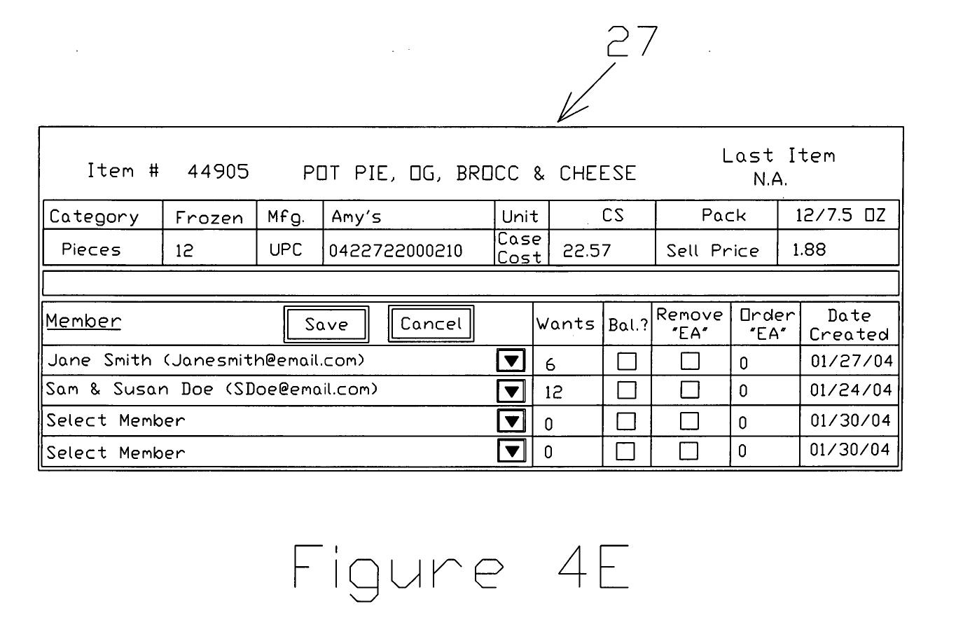

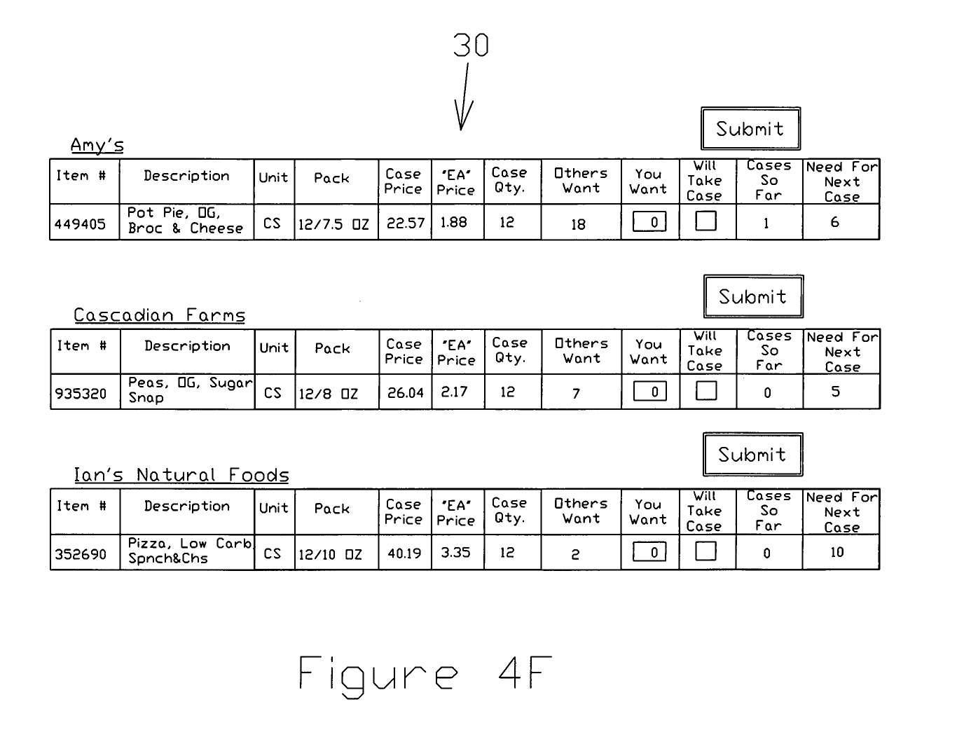

In addition to the preferred configuration shown in FIG. 1, a participating consumer may also operate a Web-TV device, a telephone, a facsimile, a personal digital assistant, a screen-phone or any appropriate device to communicate with the central controller. The central controller 20 includes the databases shown in FIGS. 3 and 4.

The component parts forming the system will be readily understood by those skilled in the art of credit card processing and computer data processing systems. Accordingly, for purposes of brevity, detailed discussions of such component parts are omitted.

It should be noted that the couplings and connections found in this system illustrates many of the interconnections that allow for the functionality and interoperability of the individual components that form the system. The participating consumer 10 is coupled to the Internet 50 or other such network through a link which may be a telephone line, an ISDN line, modem line or any such other network connection that allows data communications between a network and a remote terminal. The links shown in FIG. 1 allow for the communication of purchase related information such as customer name, identification numbers, product names and identification numbers, credit card numbers and the like.

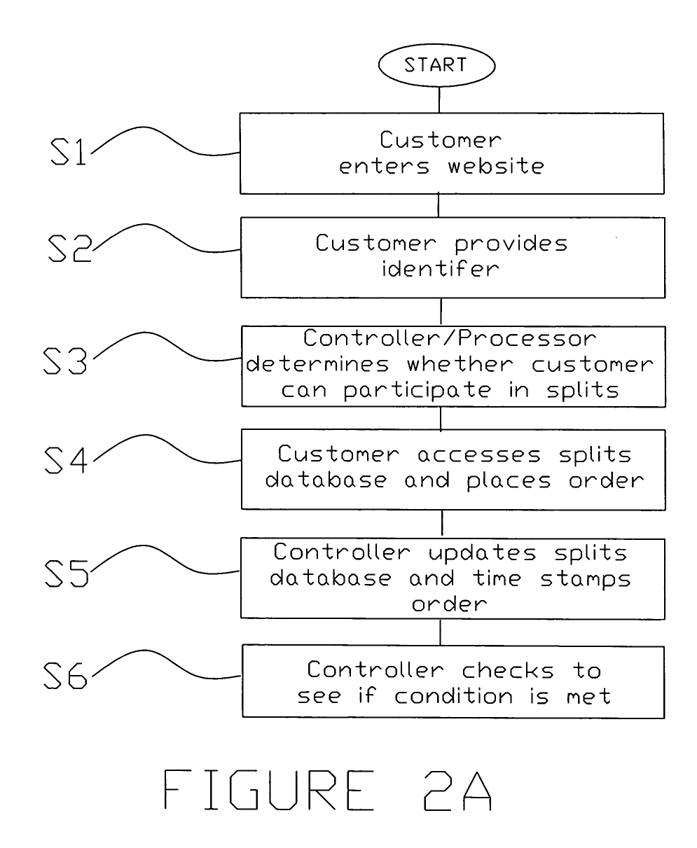

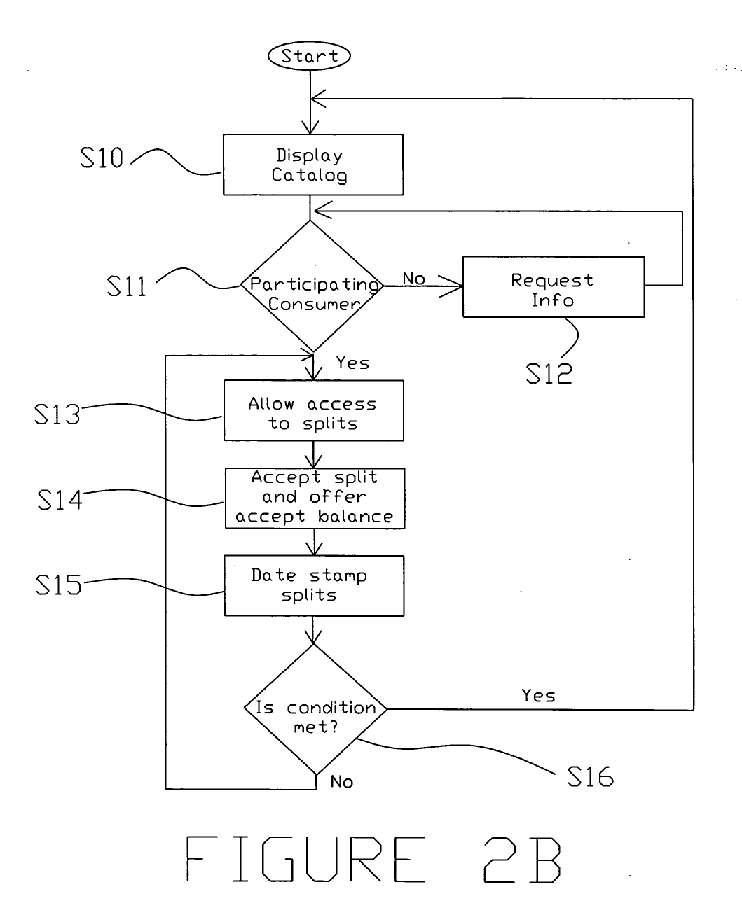

There is shown in FIGS. 2A and 2B preferred methods for carrying out the method of the invention. It should be noted that variations to the process might be made without deviating from the spirit of this invention.

Typically, a consumer interested in participating in the present process will enter a storefront model or other such website to browse the catalogs for purchasing items, as shown in step S1. The controller 20 confirms whether the consumer is a participating consumer 10 and therefore entitled to participate in the splits program that allows consumers to purchase portions of larger bulked quantities. The customer may be cued to provide a password or other identifier in step S2. After confirming that the consumer may participate in step S3, the controller allows the consumer to access a splits database and accepts an order from the consumer. The order may include a single splits transaction or multiple splits transactions. In step S5, the controller updates the splits database and date stamps the order. Periodically, it checks to see if a certain condition is met in step S6. The condition may be a time or date period in which the split is allowed. Otherwise, the condition may be triggered when the number of individual items accounted for by participating consumer equals an amount of items sold in bulk. If the condition is met, all information in the “splits” database is transferred to a “closed splits” database to allow the “splits” database to immediately begin collecting new splits for the following order period. The “closed splits” database may be a mirror image of the first database or it may only include information for tracking the individual consumer and his purchases. The consumer may also be allowed to take the balance of any case or larger quantity of goods to fill an order if the number of bulk items ordered does not equal or exceed the amount of bulk packaged item within a certain time period or before a date.

In FIG. 2B, the central controller 20 displays a catalog in step S10. In step S11, the controller 20 determines whether a consumer, who is linked to databases having data necessary for carrying out the invention, is a participating consumer 10 and may therefore place an order. If the controller 20 determines that the consumer is not a participating consumer 20, it directs the consumer to enter the requisite information for becoming a participating consumer 10 in step S12. Upon confirmation of the information, the participating consumer 10 is allowed to access a “splits” database, in step S13. The controller 20 then accepts the split and offers the participating consumer 10 to accept more of the remaining balance of the “unaccounted for” product of a larger bulk quantity when a date period condition is met in step S14. The controller next date stamps the split information in step S15 to allow consumers who order at an earlier date to take priority over those ordering at a later date. The controller 20 then determines whether a condition is met in step S16.

Referring now to FIG. 3, a central controller 20 includes a processor 21 and a data storage system. The processor is conventional and a computer system adapted to run software programs and that is configured with communications equipment such as Internet connection and telephony equipment.

The data storage system 15 is preferably any form of mass storage device configured to read and write data in a file storage device, e.g. magnetic or optical data storage devices. It should be noted that the data storage system may be one that comprises multiple disk sub-systems that may be geographically dispersed and coupled via network architecture. The processor and data storage system are coupled via a link that may include a bus or network architecture.

Stored with the data storage system are database tables forming a database management system maintained by the central controller. In particular, the data storage system may include database tables shown or those previously mentioned above. In the preferred embodiment, the data storage system includes a table on product information 22, customer information 23, operating instructions 24, splits 25, catalogs 26, add/change splits 27 and split cases or inventory 28 databases.

FIG. 4A is an example of a database that includes product information 22. Typically, this database includes a unique item number assigned to each item offered for sale. A category is assigned to each item to describe the type of item such as frozen, perishable or grocery. The manufacturer of the item is identified, as well as the size of the bulk-packaged unit. The number of units per bulk package and size of each individual item is listed. The number cost or value of the individual items is shown. The available quantity and number of requests may also be shown in this database. An option is offered to each consumer to take a balance of a bulk unit when a purchase period is closed. This allows a consumer to purchase unaccounted for items to fill a case for ordering. The total desired number is shown as well as a fill space.

FIG. 4B is a database 23 including customer information. Typically, the customer information included in this database is customer name and unique identifier. Contact information such as telephone number, email address, and physical address is also included in the database. Credit card information such as credit card number and expiration date may also be included in this database.

Now turning to FIG. 4C that shows a database 25, there are shown several categories relating to product information and listing products that are available for splitting. This database is linked to a participating consumer and allows the consumer to place an order and request an item that is bulk packaged. Each product is assigned an item number for readily tracking ordered items. A category is shown that categorizes the various types of items into whether they are frozen, grocery or perishable items. Each manufacturer of the products is displayed and a link to the manufacturers' home webpage may be provided for obtaining various nutritional information on each product. A brief description of each product is provided along with the packaging size, for example a case, crate or bag. A packaging category denotes the total number of items and the size of the items in each packaging size. The total number of items per bulk package is displayed. A cost per bulk packaging size is also displayed. Available quantities are displayed along with the number of required amount of bulk packages necessary for completing an order.

The participating consumer is provided with an option to purchase more or all of the remaining balance of product should the order not be filled within a deadline. For example, a consumer may elect to initially take items from a case that includes twelve and elect to purchase the balance if no one will purchase the remaining ten items. The collective desired amount of items is also displayed on this screen as well as a fill option for changing the number of items that a participating consumer will purchase.

FIG. 4D is an example of a database 26 showing a plurality of distributors and description of items that may be purchased in bulk. Shown is the unit size and the individual item size. A manufactured suggested retail price is displayed as well as a wholesale price. Typically, the administrator charges a percentage of the difference between the suggested retail price and the wholesale price for maintaining the system. A cost per package cost is displayed as well as a total savings.

FIG. 4E depicts a “splits” maintenance (entry/edit) database 27. This database includes a customer identifier such as name. It also includes the total number of items listed as shown. A flag indicates whether the customer desires to take the balance of an unordered amount of items to fill a case for ordering purposes as mentioned previously. A date stamp indicating the date that the record was recorded is included in this database, as well an option for modifying the order by adding or removing items from the order. In the preferred embodiment, the data storage system 15 includes a “closed splits” database that transfers information from database 27 relating to splits. During an open order period, the “closed splits” database serves a prior period lookup function. When a condition or trigger occurs, the information is transferred into the “closed splits” database. Information regarding splits is reset in database 27 after it has been transferred into the “closed splits” database to immediately allow database 27 to begin collecting new splits for the following order period.

FIG. 4F is an individual database 30 showing the total number of splits in which an individual may participate. A manufacturer is shown along with an item identifier and description. The bulk unit type such as a case is shown and the number of items per bulk package is displayed. The price per bulk unit type is included along with a price per item. The number of cases or bulk units filled may be displayed along with the number of items other participating consumers have ordered. The amount desired is listed as well as whether the consumer with take the balance of an unaccounted for portion of the bulk items. The remaining total needed too fill the next case may also be displayed.

I claim:

1. A microprocessor based process that combines the individual purchasing power of consumers to purchase products in bulk from a wholesaler at a discounted cost that is less than a cost when said products are purchased individually from a retailer of such goods, said process comprising:
displaying products to be purchased in large quantities on a participating consumer's terminal;
choosing the desired number of products and using a data entry means to enter a desired quantity;
updating the information entered by the participating consumer, such that the total number of items per product is periodically updated; and
automatically placing an order when a triggering condition occurs.

2. The microprocessor based process of claim 1 further including copying information relating to individual ordered items that comprise a larger bulk unit from a first database to a second database after the triggering condition has been met or flagging information in the first database and thereafter resetting fields in the first database that indicate an ordered amount.

3. The microprocessor based process of claim 1 further including storing unique information relating to participating consumers.

4. The microprocessor based process of claim 1 further comprising allowing a participating consumer to purchase unaccounted for items that comprise a larger bulk unit after a predetermined period of time.

5. An apparatus comprising:
a processor;
a storage device coupled to said processor and storing instructions adapted to be executed by said processor to allow an anonymous consumer to participate in purchasing individual items from a bulk package comprising the individual items to be sold at a discounted price, said storage device including information relating to individual items to be purchased in large quantities on a consumer's display device; and
instructions that cause the processor to copy information relating to accounted for individual items from a first database to a second database, or flag information in a database.

6. The apparatus of claim 5 further including instructions that determine whether a condition has been met before copying the information relating to accounted for individual items from the first database to the second database, or flagging such information in the database.

7. The apparatus of claim 5 further including instructions that allow a consumer to purchase unaccounted for items that comprise a larger bulk unit after a predetermined period of time.

8. A medium storing instructions adapted to be executed by a processor to perform a method for processing a transaction, said method comprising:
displaying products to be purchased in large quantities on a participating consumer's terminal;
choosing the desired number of products and using a data entry means to enter a desired quantity;
updating the information entered by the participating consumer, such that the total number of items per product is periodically updated; and,
automatically placing an order when a triggering condition occurs.

9. The medium of claim 8 wherein said method further comprises copying information relating to individual ordered items that comprise a larger bulk unit from a first database to a second database after the triggering condition has been met and thereafter resetting fields in the first database that indicate an ordered amount or flagging such information in the database.

10. The medium of claim 8 wherein said method further comprises storing unique information relating to participating consumers.

11. The medium of claim 8 wherein said method further comprises allowing a participating consumer to purchase unaccounted for items that comprise a larger bulk unit after a predetermined period of time.
